(19) United States
(12) Patent Application Publication
(10) Pub. No.: US 2002/0072970 A1
(43) Pub. Date: Jun. 13, 2002

(54) Method and apparatus for linking consumer product interest with product suppliers

(76) Inventors: Michael Miller, Pompano Beach, FL (US); Gregory P. Miller, Coral Springs, FL (US)

Correspondence Address: ANTHONY R BARKUME, GREENBERG TRAURIG, 885 THIRD AVENUE, NEW YORK, NY, 10022, US

(21) Appl. No.: 09/795,919

(22) Filed: Feb. 27, 2001

Related U.S. Application Data
(60) Provisional application No. 60/185,963, filed on Mar. 1, 2000.

(51) Int. Cl. G06F 17/60

(52) U.S. Cl. 705/14

(57) ABSTRACT

A method and system are provided for collecting product-specific information from a collecting device, which is transmitted to a facilitating organization where information is aggregated and provided to product suppliers in an anonymous fashion.

### RELATED APPLICATIONS

This application claims priority from U.S. Provisional Patent Application entitled METHOD AND APPARATUS FOR LINKING CONSUMER PRODUCT INTEREST WITH PRODUCT SUPPLIERS, Application No. 60/185,963 and filed Mar. 01, 2000 and which is incorporated by reference in its entirety for all purposes.

### FIELD OF THE INVENTION

This invention relates generally to a method and system for collecting product-specific information from a collecting device, which is transmitted to a facilitating organization where information is aggregated and provided to product suppliers in an anonymous fashion. The information reveals to the supplier that certain identified people (which may be anonymous) are interested in specific products. The data can be organized to reveal demographic, date, quantity and other details about the data. Messages and other communications, such as offers to buy or sell a product, may be passed between the parties w/o comprising an individual user's privacy.

### BACKGROUND

Historically, suppliers of products, such as retailers and manufacturers, have had no mechanism that allows them to detect consumers who are interested in their products but who have not yet made a purchase. As such, marketing efforts must be conducted in a broad scale manner in order to reach their target audience. This method is, of course, highly inefficient, and the objective is to be as target-specific as possible. The ideal scenario is to target marketing efforts only to those users having interest in their products.

Traditionally, manufacturers and retailers can only respond to potential customers on a one-on-one basis after a person proactively contacts them. Electronic environments such as the Internet and bulletin-board services (BBS) have allowed manufacturers and retailers to provide information, pricing, and special offers about their products to a mass market. However, they have no way of identifying specific individuals interested in their products unless the users specifically contact them. A user is often forced to provide a supplier with personal information such as their name, a telephone number, residential address, email address, etc. Users are often hesitant to provide such information for fear of unwanted contact by the manufacturer or retailer (e.g., “spam”).

The supplier also has no way to provide special incentives to select consumers. For example, a retail company has to offer a discount price to everyone who walks in the store, even those persons who have already purchased their product or would have purchased it without a discount. A manufacturer that issues a coupon must extend that offer to everyone who receives it. An Internet web site engaged in e-commerce must post special offers that are applicable to everyone who accesses the site.

Thus, there is currently no way for manufacturers, retailers and other product suppliers to contact individuals who are interested in a particular product but who have not pro actively contacted them.

### SUMMARY OF THE INVENTION

A method and system are provided for collecting product-specific information from a user's collecting device, which is transmitted to a facilitating organization where information is aggregated and provided to product suppliers in an anonymous fashion. The information reveals to the supplier that certain identified people (which may be anonymous) are interested in specific products. The data can be organized to reveal demographic, date, quantity and other details about the data. Messages and other communications, such as offers to buy or sell a product, may be passed between the parties w/o comprising an individual user's privacy. A transaction between the user and the supplier can be facilitated.

### BRIEF DESCRIPTION OF THE DRAWINGS

The invention will be better understood when consideration is given to the following detailed description thereof. Such description makes reference to the annexed drawings wherein:

FIG. 1 is a schematic diagram of a hardware implementation of one embodiment of the present invention;

FIG. 2 illustrates an exemplary system with a plurality of components in accordance with one embodiment of the present invention;

FIG. 3 illustrates a process for gathering product specific information;

FIG. 4 illustrates one configuration of an electronic form that may be provided to or used by a supplier; and

FIG. 5 demonstrates an exemplary “Special Offers” section of a user's personalized web page at the facilitating organization.

### DETAILED DESCRIPTION OF THE PREFERRED EMBODIMENTS

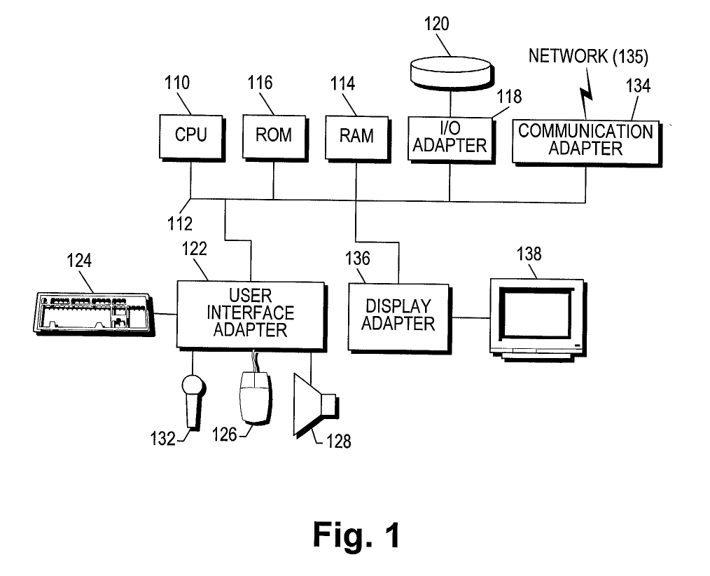

An embodiment of a system in accordance with the present invention may be practiced in the context of a personal computer such as an IBM compatible personal computer, Apple Macintosh computer or UNIX based workstation. A representative hardware environment is depicted in FIG. 1, which illustrates a typical hardware configuration of a workstation in accordance with a preferred embodiment having a central processing unit 110, such as a microprocessor, and a number of other units interconnected via a system bus 112. The workstation shown in FIG. 1 includes a Random Access Memory (RAM) 114, Read Only Memory (ROM) 116, an I/O adapter 118 for connecting peripheral devices such as disk storage units 120 to the bus 112, a user interface adapter 122 for connecting a keyboard 124, a mouse 126, a speaker 128, a microphone 132, and/or other user interface devices such as a touch screen (not shown) to the bus 112, communication adapter 134 for connecting the workstation to a communication network (e.g., a data processing network) and a display adapter 136 for connecting the bus 112 to a display device 138. The workstation typically has resident thereon an operating system such as the Microsoft Windows NT or Windows/95 Operating System (OS), the IBM OS/2 operating system, the MAC OS, or UNIX operating system. Those skilled in the art will appreciate that the present invention may also be implemented on platforms and operating systems other than those mentioned.

An embodiment of the present invention may be written using JAVA, C, and the C++ language and utilize object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of structures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics of a standard piston defined in the piston engine class. However, the ceramic piston engine object overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:

Objects can represent physical objects, such as automobiles in a traffic-flow simulation, electrical components in a circuit-design program, countries in an economics model, or aircraft in an air-traffic-control system.

Objects can represent elements of the computer-user environment such as windows, menus or graphics objects.

An object can represent an inventory, such as a personnel file or a table of the latitudes and longitudes of cities.

An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:

Objects and their corresponding classes break down complex programming problems into many smaller, simpler problems.

Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch.

Polymorphism and multiple inheritance make it possible for different programmers to mix and match characteristics of many different classes and create specialized objects that can still work with related objects in predictable ways.

Class hierarchies and containment hierarchies provide a flexible mechanism for modeling real-world objects and the relationships among them.

Libraries of reusable classes are useful in many situations, but they also have some limitations. For example:

Complexity. In a complex system, the class hierarchies for related classes can become extremely confusing, with many dozens or even hundreds of classes.

Flow of control. A program written with the aid of class libraries is still responsible for the flow of control (i.e., it must control the interactions among all the objects created from a particular library). The programmer has to decide which functions to call at what times for which kinds of objects.

Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer must still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:

Behavior versus protocol. Class libraries are essentially collections of behaviors that you can call when you want those individual behaviors in your program. A framework, on the other hand, provides not only behavior but also the protocol or set of rules that govern the ways in which behaviors can be combined, including rules for what a programmer is supposed to provide versus what the framework provides.

Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.

Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the server. HTTP or other protocols could be readily substituted for HTML without undue experimentation. Information on these products is available in T. Berners-Lee, D. Connoly, “RFC 1866: Hypertext Markup Language-2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996).

HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:

Poor performance;

Restricted user interface capabilities;

Can only produce static Web pages;

Lack of interoperability with existing applications and data; and

Inability to scale.

Sun Microsystems's Java language solves many of the client-side problems by:

Improving performance on the client side;

Enabling the creation of dynamic, real-time Web applications; and

Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance.

Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C++. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

Transmission Control Protocol/Internet Protocol (TCP/IP) is a basic communication language or protocol of the Internet. It can also be used as a communications protocol in the private networks called intranet and in extranet. When you are set up with direct access to the Internet, your computer is provided with a copy of the TCP/IP program just as every other computer that you may send messages to or get information from also has a copy of TCP/IP.

TCP/IP is a two-layering program. The higher layer, Transmission Control Protocol (TCP), manages the assembling of a message or file into smaller packet that are transmitted over the Internet and received by a TCP layer that reassembles the packets into the original message. The lower layer, Internet Protocol (IP), handles the address part of each packet so that it gets to the right destination. Each gateway computer on the network checks this address to see where to forward the message. Even though some packets from the same message are routed differently than others, they'll be reassembled at the destination.

TCP/IP uses a client/server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. (Note that the TCP layer itself is not stateless as far as any one message is concerned. Its connection remains in place until all packets in a message have been received.).

Many Internet users are familiar with the even higher layer application protocols that use TCP/IP to get to the Internet. These include the World Wide Web's Hypertext Transfer Protocol (HTTP), the File Transfer Protocol (FTP), Telnet which lets you logon to remote computers, and the Simple Mail Transfer Protocol (SMTP). These and other protocols are often packaged together with TCP/IP as a “suite.” Personal computer users usually get to the Internet through the Serial Line Internet Protocol (SLIP) or the Point-to-Point Protocol. These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX)is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does).

Packet acknowledgment is managed by another Novell protocol, the Sequenced Packet Exchange (SPX). Other related Novell NetWare protocols are: the Routing Information Protocol (RIP), the Service Advertising Protocol (SAP), and the NetWare Link Services Protocol (NLSP).

A virtual private network (VPN) is a private data network that makes use of the public telecommunication infrastructure, maintaining privacy through the use of a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data.

Using a virtual private network involves encryption data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPP) and Microsoft has extended Windows NT to support it. VPN software is typically installed as part of a company's firewall server.

Wireless refers to a communications, monitoring, or control system in which electromagnetic radiation spectrum or acoustic waves carry a signal through atmospheric space rather than along a wire. In most wireless systems, radio frequency (RF) or infrared transmission (IR) waves are used. Some monitoring devices, such as intrusion alarms, employ acoustic waves at frequencies above the range of human hearing.

Early experimenters in electromagnetic physics dreamed of building a so-called wireless telegraph. The first wireless telegraph transmitters went on the air in the early years of the 20th century. Later, as amplitude modulation (AM) made it possible to transmit voices and music via wireless, the medium came to be called radio. With the advent of television, fax, data communication, and the effective use of a larger portion of the electromagnetic spectrum, the original term has been brought to life again.

Common examples of wireless equipment in use today include the Global Positioning System, cellular telephone phones and pagers, cordless computer accessories (for example, the cordless mouse), home-entertainment-system control boxes, remote garage-door openers, two-way radios, and baby monitors. An increasing number of companies and organizations are using wireless LAN. Wireless transceivers are available for connection to portable and notebook computers, allowing Internet access in selected cities without the need to locate a telephone jack. Eventually, it will be possible to link any computer to the Internet via satellite, no matter where in the world the computer might be located.

Bluetooth is a computing and telecommunications industry specification that describes how mobile phones, computers, and personal digital assistants (PDA's) can easily interconnect with each other and with home and business phones and computers using a short-range wireless connection. Each device is equipped with a microchip transceiver that transmits and receives in a previously unused frequency band of 2.45 GHz that is available globally (with some variation of bandwidth in different countries). In addition to data, up to three voice channels are available. Each device has a unique 48-bit address from the IEEE 802 standard. Connections can be point-to-point or multipoint. The maximum range is 10 meters. Data can be presently be exchanged at a rate of 1 megabit per second (up to 2 Mbps in the second generation of the technology). A frequency hop scheme allows devices to communicate even in areas with a great deal of electromagnetic interference. Built-in encryption and verification is provided.

Encryption is the conversion of data into a form, called a ciphertext, that cannot be easily understood by unauthorized people. Decryption is the process of converting encrypted data back into its original form, so it can be understood.

The use of encryption/decryption is as old as the art of communication. In wartime, a cipher, often incorrectly called a “code,” can be employed to keep the enemy from obtaining the contents of transmissions (technically, a code is a means of representing a signal without the intent of keeping it secret; examples are Morse code and ASCII.). Simple ciphers include the substitution of letters for numbers, the rotation of letters in the alphabet, and the “scrambling” of voice signals by inverting the sideband frequencies. More complex ciphers work according to sophisticated computer algorithm that rearrange the data bits in digital signals.

In order to easily recover the contents of an encrypted signal, the correct decryption key is required. The key is an algorithm that “undoes” the work of the encryption algorithm. Alternatively, a computer can be used in an attempt to “break” the cipher. The more complex the encryption algorithm, the more difficult it becomes to eavesdrop on the communications without access to the key.

Rivest-Shamir-Adleman (RSA) is an Internet encryption and authentication system that uses an algorithm developed in 1977 by Ron Rivest, Adi Shamir, and Leonard Adleman. The RSA algorithm is a commonly used encryption and authentication algorithm and is included as part of the Web browser from Netscape and Microsoft. It's also part of Lotus Notes, Intuit's Quicken, and many other products. The encryption system is owned by RSA Security.

The RSA algorithm involves multiplying two large prime numbers (a prime number is a number divisible only by that number and 1) and through additional operations deriving a set of two numbers that constitutes the public key and another set that is the private key. Once the keys have been developed, the original prime numbers are no longer important and can be discarded. Both the public and the private keys are needed for encryption /decryption but only the owner of a private key ever needs to know it. Using the RSA system, the private key never needs to be sent across the Internet.

The private key is used to decrypt text that has been encrypted with the public key. Thus, if I send you a message, I can find out your public key (but not your private key) from a central administrator and encrypt a message to you using your public key. When you receive it, you decrypt it with your private key. In addition to encrypting messages (which ensures privacy), you can authenticate yourself to me (so I know that it is really you who sent the message) by using your private key to encrypt a digital certificate. When I receive it, I can use your public key to decrypt it.

SMS (Short Message Service) is a service for sending messages of up to 160 characters to mobile phones that use Global System for Mobile (GSM) communication. GSM and SMS service is primarily available in Europe. SMS is similar to paging. However, SMS messages do not require the mobile phone to be active and within range and will be held for a number of days until the phone is active and within range. SMS messages are transmitted within the same cell or to anyone with roaming service capability. They can also be sent to digital phones from a Web site equipped with PC Link or from one digital phone to another.

On the public switched telephone network (PSTN), Signaling System 7 (SS7) is a system that puts the information required to set up and manage telephone calls in a separate network rather than within the same network that the telephone call is made on. Signaling information is in the form of digital packet. SS7 uses what is called out of band signaling, meaning that signaling (control) information travels on a separate, dedicated 56 or 64 Kbps channel rather than within the same channel as the telephone call. Historically, the signaling for a telephone call has used the same voice circuit that the telephone call traveled on (this is known as in band signaling). Using SS7, telephone calls can be set up more efficiently and with greater security. Special services such as call forwarding and wireless roaming service are easier to add and manage. SS7 is now an international telecommunications standard.

Speech or voice recognition is the ability of a machine or program to recognize and carry out voice commands or take dictation. In general, speech recognition involves the ability to match a voice pattern against a provided or acquired vocabulary. Usually, a limited vocabulary is provided with a product and the user can record additional words. More sophisticated software has the ability to accept natural speech (meaning speech as we usually speak it rather than carefully-spoken speech).

A tag is a generic term for a language element descriptor. The set of tags for a document or other unit of information is sometimes referred to as markup, a term that dates to pre-computer days when writers and copy editors marked up document elements with copy editing symbols or shorthand.

An Internet search engine typically has three parts: 1) a spider (also called a “crawler” or a “bot”) that goes to every page or representative pages on every Web site that wants to be searchable and reads it, using hypertext links on each page to discover and read a site's other pages; 2) a program that creates a huge index (sometimes called a “catalog”) from the pages that have been read; and 3) a program that receives your search request, compares it to the entries in the index, and returns results to you.

An alternative to using a search engine is to explore a structured directory of topics. Yahoo, which also lets you use its search engine, is a widely-used directory on the Web. A number of Web portal sites offer both the search engine and directory approaches to finding information.

Different Search Engine Approaches—Major search engines such as Yahoo, AltaVista, Lycos, and Google index the content of a large portion of the Web and provide results that can run for pages—and consequently overwhelm the user. Specialized content search engines are selective about what part of the Web is crawled and indexed. For example, TechTarget sites for products such as the AS/400 (http://www.search400.com) and Windows NT (http://www.searchnt.com) selectively index only the best sites about these products and provide a shorter but more focused list of results. Ask Jeeves (http://www.askjeeves.com) provides a general search of the Web but allows you to enter a search request in natural language, such as “What's the weather in Seattle today?” Special tools such as WebFerret (from http://www.softferret.com) let you use a number of search engines at the same time and compile results for you in a single list. Individual Web sites, especially larger corporate sites, may use a search engine to index and retrieve the content of just their own site. Some of the major search engine companies license or sell their search engines for use on individual sites.

Major search engines on the Web include: AltaVista (http://www.altavista.com), Excite (http://www.excite.com), Google (http://www.google.com), Hotbot (http://www.hotbot.com), Infoseek (http://www.infoseek.com), Lycos (http://www.lycos.com), and WebCrawler (http://www.webcrawler.com). Most if not all of the major search engines attempt to index a representative portion of the entire content of the World Wide Web, using various criteria for determining which are the most important sites to crawl and index. Most search engines also accept submissions from Web site owners. Once a site's pages have been indexed, the search engine will return periodically to the site to update the index. Some search engines give special weighting to: words in the title, in subject descriptions and keywords listed in HTML META tags, to the first words on a page, and to the frequent recurrence (up to a limit) of a word on a page. Because each of the search engines uses a somewhat different indexing and retrieval scheme (which is likely to be treated as proprietary information) and because each search engine can change its scheme at any time, we haven't tried to describe these here.

A definition of an IP Address may be based on Internet Protocol Version 4 (Note: that the system of IP address classes described here, while forming the basis for IP address assignment, is generally bypassed today by use of Classless Inter-Domain Routing addressing.

In the most widely installed level of the Internet Protocol today, an IP address is a 32-binary digit number that identifies each sender or receiver of information that is sent in packet across the Internet. When you request an HTML page or send e-mail, the Internet Protocol part of TCP/IP includes your IP address in the message (actually, in each of the packets if more than one is required) and sends it to the IP address that is obtained by looking up the domain name in the Uniform Resource Locator you requested or in the e-mail address you're sending a note to. At the other end, the recipient can see the IP address of the Web page requester or the e-mail sender and can respond by sending another message using the IP address it received.

An IP address has two parts: the identifier of a particular network on the internet and an identifier of the particular device (which can be a server or a workstation) within that network. On the Internet itself—that is, between the router that move packets from one point to another along the route—only the network part of the address is looked at.

The Network Part of the IP Address—The Internet is really the interconnection of many individual networks (it's sometimes referred to as an internetwork). So the Internet Protocol is basically the set of rules for one network communicating with any other (or occasionally, for broadcast messages, all other networks). Each network must know its own address on the Internet and that of any other networks with which it communicates. To be part of the Internet, an organization needs an Internet network number, which it can request from the Network Information Center (NIC). This unique network number is included in any packet sent out of the network onto the Internet.

The Local or Host Part of the IP Address—In addition to the network address or number, information is needed about which specific machine or host in a network is sending or receiving a message. So the IP address needs both the unique network number and a host number (which is unique within the network). (The host number is sometimes called a local or machine address.)

Part of the local address can identify a subnetwork or subnet address, which makes it easier for a network that is divided into several physical subnetworks (for examples, several different local area networks or ) to handle many devices.

IP Address Classes and Their Formats—Since networks vary in size, there are four different address formats or classes to consider when applying to NIC for a network number:

Class A addresses are for large networks with many devices.

Class B addresses are for medium-sized networks.

Class C addresses are for small networks (fewer than 256 devices).

Class D addresses are multicast addresses.

The first few bits of each IP address indicate which of the address class formats it is using. The address structures look like this:

The IP address is usually expressed as four decimal numbers, each representing eight bits, separated by periods. This is sometimes known as the dot address and, more technically, as dotted quad notation. For Class A IP addresses, the numbers would represent “network.local.local.local”; for a Class C IP address, they would represent “network.network.network.local”. The number version of the IP address can (and usually is) represented by a name or series of names called the domain name.

The Internet's explosive growth makes it likely that, without some new architecture, the number of possible network addresses using the scheme above would soon be used up (at least, for Class C network addresses). However, a new IP version, Ipv6, expands the size of the IP address to 128 bits, which will accommodate a large growth in the number of network addresses. For hosts still using IPv4, the use of subnet in the host or local part of the IP address will help reduce new applications for network numbers. In addition, most sites on today's mostly IPv4 Internet have gotten around the Class C network address limitation by using the Classless Inter-Domain Routing scheme for address notation.

Relationship of the IP Address to the Physical Address—The machine or physical address used within an organization's local area networks may be different than the Internet's IP address. The most typical example is the 48-bit Ethernet address. TCP/IP includes a facility called the Address Resolution Protocol that lets the administrator create a table that maps IP addresses to physical addresses. The table is known as the ARP cache.

Static versus Dynamic IP Addresses—The discussion above assumes that IP addresses are assigned on a static basis. In fact, many IP addresses are assigned dynamically from a pool. Many corporate networks and online services economize on the number of IP addresses they use by sharing a pool of IP addresses among a large number of users. If you're an America Online user, for example, your IP address will vary from one logon session to the next because AOL is assigning it to you from a pool that is much smaller than AOL's 15 million subscribers.

A Uniform Resource Locator (URL) is the address of a file (resource) accessible on the Internet. The type of resource depends on the Internet application protocol. Using the World Wide Web's protocol, the Hypertext Transfer Protocol, the resource can be an HTML page, an image file, a program such as a common gateway interface application or Java applet, or any other file supported by HTTP. The URL contains the name of the protocol required to access the resource, a domain name that identifies a specific computer on the Internet, and a hierarchical description of a file location on the computer.

On the Web (which uses the Hypertext Transfer Protocol), an example of a URL is:

http://www.mhrcc.org/kingston

which describes a Web page to be accessed with an HTTP (Web browser) application that is located on a computer named www.mhrcc.org. The specific file is in the directory named /kingston and is the default page in that directory (which, on this computer, happens to be named index.html).

An HTTP URL can be for any Web page, not just a home page, or any individual file. For example, this URL would bring you the whatis.com logo image:

http://whatis.com/whatisAnim2.gif

A URL for a program such as a forms-handling common gateway interface script written in Practical Extraction and Reporting Language might look like this:

http://whatis.com/cgi-bin/comments.pl

A URL for a file meant to be downloaded would require that the “ftp” protocol be specified like this one:

ftp://www.somecompany.com/whitepapers/widgets.ps

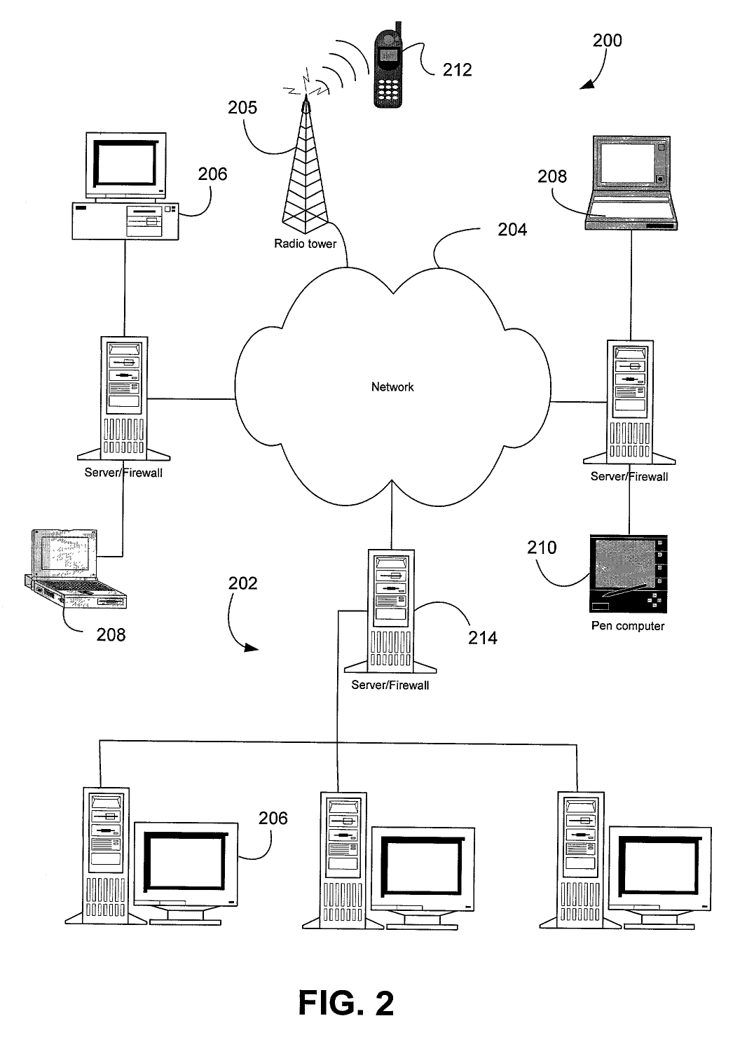

FIG. 2 illustrates an exemplary system 200 with a plurality of components 202 in accordance with one embodiment of the present invention. As shown, such components include a network 204 which take any form including, but not limited to a local area network, a wide area network such as the Internet, and a wireless network 205. Coupled to the network 204 is a plurality of computers which may take the form of desktop computers 206, lap-top computers 208, hand-held computers 210 (including wireless devices 212 such as wireless PDA's or mobile phones), or any other type of computing hardware/software. As an option, the various computers may be connected to the network 204 by way of a server 214 which may be equipped with a firewall for security purposes. It should be noted that any other type of hardware or software may be included in the system and be considered a component thereof.

In one embodiment of the present invention a system and method are provided in which a manufacturer or retailer has the ability to easily present product-specific information such as pricing, manuals, or special offers to specific individuals who have an interest in such products in such a manner that does not violate consumer privacy.

Various input devices such as bar code scanners, voice tape recorders, mobile cellular telephones, etc. can be employed by users (e.g., consumers) to collect information about a product or products. Specifically, information such as a Universal Product Code (UPC), Stock-Keeper Units (SKU's), manufacturers part numbers or product descriptions, etc. (e.g., unique identifiers that allow users to collect information about products) can be collected (e.g., by being scanned by a bar code scanner) and transmitted via a computer to a larger network that includes suppliers of such information and products.

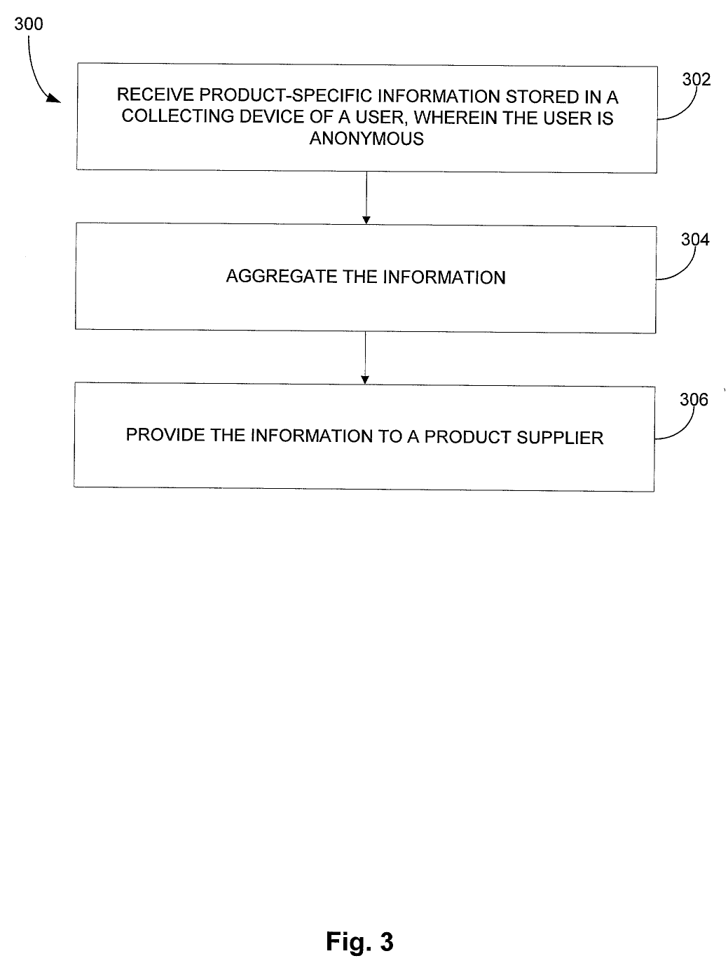

FIG. 3 illustrates a process 300 for gathering product specific information. In operation 302, a facilitating organization receives the unique identifiers collected by users and, in operation 304, aggregates information (e.g., the identifiers) for forwarding to suppliers in operation 306. Users may be shielded from suppliers during this process to protect their identities and their privacy. Suppliers can then make offers concerning their products, to an interested user, via the facilitating organization. The offers may be presented on a publicly accessible posting (e.g., the Internet), a private network of computers, or any other system that can be accessed by users' computers.

An exemplary method of the invention includes:

(1) collecting product specific information by a user;

(2) transmitting the information into a computing device ( e.g., a personal computer);

(3) receiving the information from the computing device at a facilitating organization over a communication link (e.g., a modem, dedicated telephony connection, or other link that interconnects computing devices);

(4) aggregating and storing information by the facilitating organization (the information may be sorted by product category or other criteria);

(5) transmitting information concerning users' product interests to suppliers based upon their product categories or other specified criteria;

(6) receiving product (sales) offers at the facilitating organization from suppliers after they review the information concerning users' interests;

(7) placing the offers in a holding area (e.g., on the organization's computer system(s)) that is accessible to users who collected or submitted the associated product information;

(8) receiving a decision from a consumer concerning whether or not to accept a supplier's offer;

(9) if an offer is accepted, facilitating a transaction between the organization and a user.

One embodiment of the invention is particularly suitable for use with a system and method for consumers to collect information about various products that they are interested in. One such system is disclosed in U.S. patent application Ser. No. 091296,479 entitled: SYSTEM AND METHOD FOR PROVIDING ELECTRONIC INFORMATION UPON RECEIPT OF A BAR CODE. A method associated with this system allows users to collect unique identifying information about a product such as a Universal Product Code (UPC), Stock-Keeper Unit (SKU) or other similar identifier. A personal device may be employed to allow the user to collect the unique identifiers for a multitude of products, which identifiers are stored in the device's memory. The device may be battery-powered and have the ability to stored hundreds of identifiers over a long period of time.

In one embodiment of the invention a consumer or other user employs a portable device to collect identifiers for one or more products that interest the user. After one or more identifiers are collected, the product information (e.g., the collected identifiers) is transmitted into a computing device (e.g., a personal computer). A receiving device may be connected to the personal computer to receive the product information from the collecting device on behalf of the computer. The receiving device may be connected via an interface such as a serial port, parallel port, universal serial bus (USE), keyboard, etc. The receiving device illustratively receives the following information: (1) a special control code sequence; (2) a unique identifier (e.g., of the user, the user's collecting device, a provider of the collecting device, etc.); (3) a list of one or more unique product identifiers and, for each product identifier, data indicating the type of identifier, (e.g., UPC, SKU, part number); (4) a unique code that signifies to the receiving unit that all data has been transmitted. A subset or superset of this information may be received in an alternative embodiment.

Illustratively, the special control code sequence serves the purpose of activating a client-side software application that resides on the user's personal computer. The software may normally be in a quiescent or sleep mode, and only be activated upon receipt of this unique control code sequence.

The software application itself connects to a facilitating organization's web site or other accessible electronic environment. The application first ensures that the user has a connection to the Internet or other communication service (e.g., through a local service provider). In the event a suitable connection is not detected, it attempts to connect via a modem, dedicated connection, or other method.

Once a connection to the facilitating organization is verified, the client-side software application automatically accesses the web page of the facilitating organization by connecting to a specific Internet Protocol (IP) address or other network address. Once connected to the facilitating organization, a general or specific description is provided concerning the products that were scanned by the user's collecting device. This may be accomplished by cross-referencing the unique identifier (e.g., UPC) with available information for the product(s) pertaining to the unique identifier. Thus, product information that is provided may include a complete description of a product, a graphical image, manufacturer's suggested retail price (MSRP), a list of locations to purchase the product, product reviews, and other relevant data.

The facilitating organization's web site may also retrieve information relating to identifiers previously collected by the user. Illustratively, the user's scans may be saved and/or cataloged according to a unique identification code assigned to the scanner itself.

The facilitator's database may therefore be able to identify the user from previously obtained profile information that resides in the database. The user interface itself may integrate recently scanned products with current products, any or all of which may be kept until the user discards unwanted information. Thus, a personal interface may be provided to each user, based on his or her history of product interests and product identifiers that he or she submitted. This personal interface may be used as the first web page displayed for a user when he or she connects to the facilitating organization.

The facilitator's database may record the date that data is transmitted to the organization from the user. The date may then be stored in the database along with product identifiers, descriptions, etc. The facilitator's software may automatically query the entire database of users for products that have not been purchased by a user within a pre-determined amount of time (e.g., seven days). The application may then aggregate all of the users' requests and sort them by date, product, supplier or other criteria. “Stale” data (e.g., information relating to products scanned and submitted by a consumer some time ago) may be purged after some time or archived. In one ” embodiment of the invention stale data may be provided to a broker or other party (e.g., a supplier other than the supplier originally notified of a consumer's interest in a product) that can make use of consumer's specified product interests.

Illustratively, the facilitator then notifies an appropriate supplier concerning consumer interest in the supplier's product. The supplier may be allowed a view into the facilitator's database to verify consumers' interest in particular products.

Information presented to the supplier or manufacturer may include any or all of: (1) user number or identifier, (2) product number or unique identifier (e.g., UPC, SKU), (3) product code, (4) lowest price found, (5) date requested by customer. Other information may be provided in other embodiments of the invention. The facilitating organization may sort the requests by specific criteria such as geography, demographics, etc.

The supplier may then respond to a consumer's interest by sending back to the consumer any or all of the following information; (1) a special price or offer, (2) offer expiration date; (3) special incentives, and (4) a special tracking number.

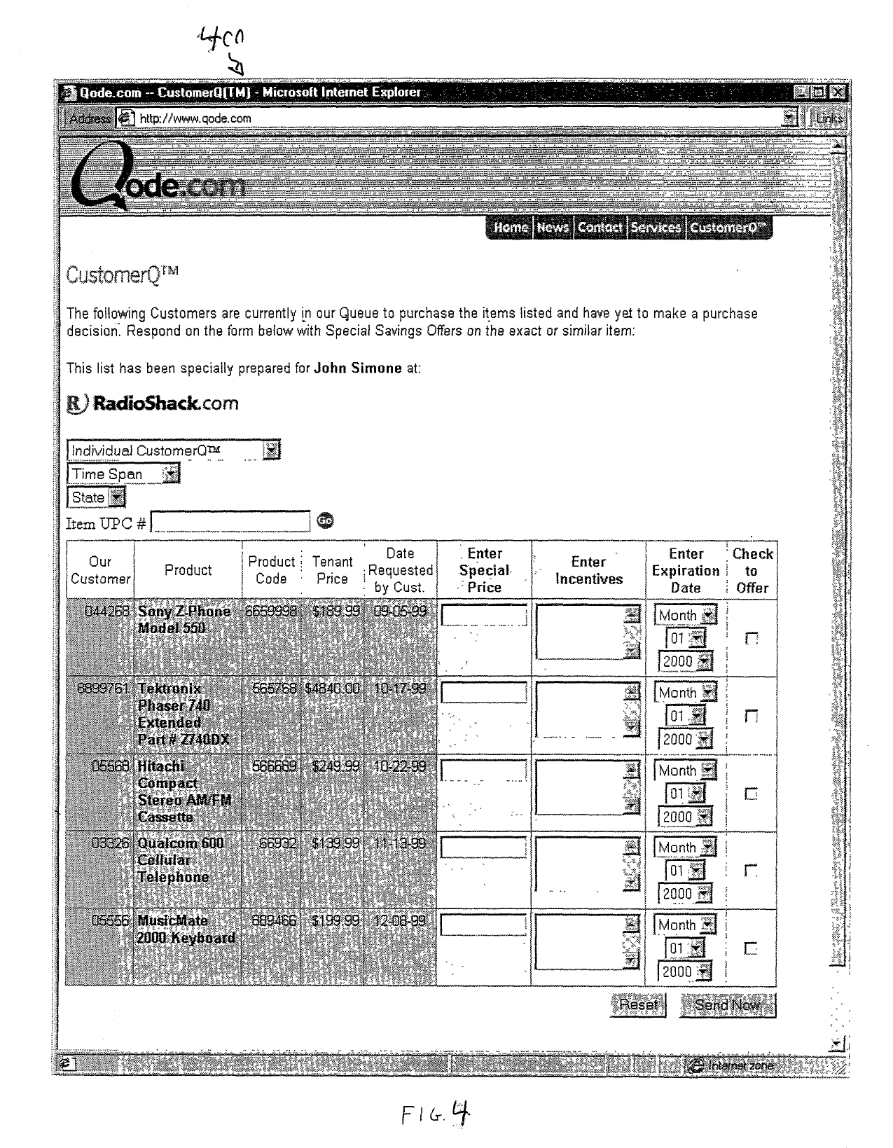

FIG. 4 illustrates one configuration of an electronic form 400 that may be provided to or used by a supplier. Illustratively, the form reveals a product offered or carried by the supplier, an anonymous identifier of a customer interested in the product, the date the customer expressed an interest in the product, etc. In the illustrated embodiment, the form also allows the supplier to enter an offer or special offer for a customer. If the supplier decides to respond to a customer's interest by making an offer, the supplier may specify a price for the product, an expiration date, product information, extra incentives, etc. In alternative embodiments of the invention the form may include any of the preceding information and/or other information that may be helpful or of interest to a supplier or customer.

The electronic form provided to or used by a supplier may allow a supplier to sort or view users and product interests by criteria such as location of user (e.g., state, city, region, zip code), dates of product interest, customer identifier, product, par code ( e.g., UPC, SKU), etc.

In one embodiment of the invention the information provided to a supplier by the facilitating organization is part of an electronic form. The supplier may review the form, provide information to be returned to one or more consumers and then forward the amended form back to the facilitating organization. Illustratively, this is conducted in an electronic fashion such as through http (HyperText Transport Protocol) requests, ftp (File Transfer Protocol), or other similar protocols or mechanisms. The form that is provided to or used by the supplier may be constructed manually or automatically (e.g., possibly using artificial intelligence or learned behavior to generate a suitable offer to a consumer).

Once the facilitating organization receives an offer or other information from the supplier, the return information is stored in a database that may be linked to one or more particular customers (e.g., a customer to whom the supplier directed an offer).

The facilitating organization may then supply this information back to the consumer in a non-intrusive fashion. This may be done, for example, by posting the special offer to the user on the organization's website (e.g., through the user's personal interface). The next time the user logs onto the website, they are granted access to a special “Offers” portion of the site that is tailored to the user. Any special offers that have been received by a supplier for the user are presented to the user.

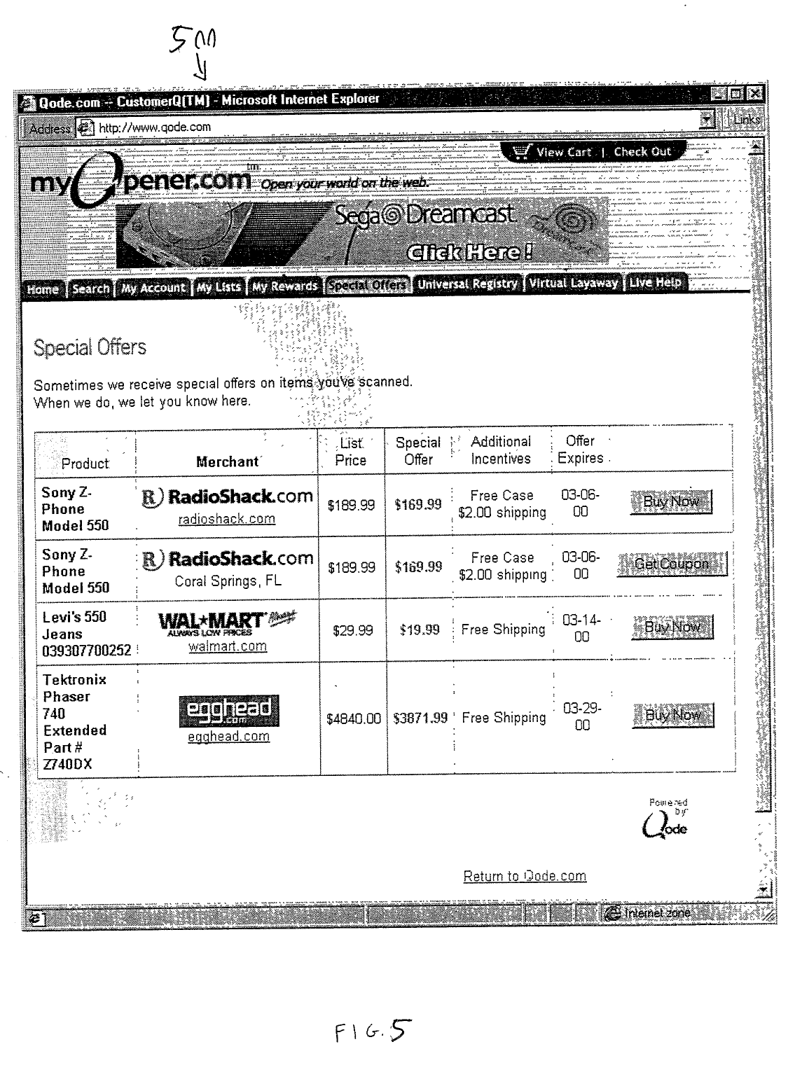

FIG. 5 demonstrates an exemplary “Special Offers” section of a user's personalized web page 500 at the facilitating organization. As illustrated, the user is presented with a list of one or more products in which he or she expressed an interest. F or each product, a supplier is identified and an offer targeted to the user for the product is revealed, with any pertinent data (e.g., price, color, quantity, expiration of offer). An offer may include free-form information from the supplier to the user, such as extra incentives (e.g., free warranty, free shipping, related products). Illustratively, in the Special Offers section, a user is able to connect to a supplier or make a purchase by selecting an appropriate icon or link.

If the customer is interested in acting upon the special offer, they may simply click on a “buy” section of an electronic form that displays the offer. This acceptance of the supplier's offer is sent to the supplier, possibly using XML (eXtensible Markup Language), http-post, ED! (Electronic Data Interchange) Link, Fax, email, or some other electronic communication method. The supplier may be given customer-specific information such as name, address, telephone number, as well as the product and description along with the special offer ( or some identifier of the offer to which the customer is responding) and/or any special tracking number the supplier may have used.

While various embodiments have been described above, it should be understood that they have been presented by way of example only, and not limitation. Thus, the breadth and scope of a preferred embodiment should not be limited by any of the above described exemplary embodiments, but should be defined only in accordance with the following claims and their equivalents.

What is claimed is:

1. A method for manipulating product-specific information, comprising the steps of:
(a) receiving product-specific information stored in a collecting device of a user, wherein the user is anonymous;
(b) aggregating the information; and
(c) providing the information to a product supplier.

2. A method as recited in claim 1, wherein the information is organized to reveal at least one of demographic, date, and quantity.

3. A method as recited in claim 1, wherein communications are passed between the user and the supplier.

4. A method as recited in claim 3, wherein the communications include a product offer.

5. A method as recited in claim 4, further comprising the step of assisting in a transaction between the user and the supplier.

6. A system for manipulating product-specific information, comprising:
(a) logic for receiving product-specific information stored in a collecting device of a user, wherein the user is anonymous;
(b) logic for aggregating the information; and
(c) logic for providing the information to a product supplier.

7. A system as recited in claim 6, wherein the information is organized to reveal at least one of demographic, date, and quantity.

8. A system as recited in claim 6, wherein communications are passed between the user and the supplier.

9. A system as recited in claim 8, wherein the communications include a product offer.

10. A system as recited in claim 9, further comprising logic for assisting in a transaction between the user and the supplier.
